(19) United States
(12) Patent Application Publication
(10) Pub. No.: US 2026/0342593 A1
(43) Pub. Date: Oct. 29, 2026

(54) SYSTEMS AND METHODS FOR USING A SIGNED CERTIFICATE FOR BOOT KEYS OF AN INFORMATION HANDLING SYSTEM

(71) Applicant: Dell Products L.P., Round Rock, TX (US)

(72) Inventors: Eugene David Cho, Austin, TX (US); Mukund P. Khatri, Austin, TX (US)

(73) Assignee: Dell Products L.P., Round Rock, TX (US)

(21) Appl. No.: 19/190,870

(22) Filed: Apr. 28, 2025

(51) Int. Cl. H04L 9/32; G06F 21/57; H04L 9/08

(52) U.S. Cl. CPC H04L 9/3263; G06F 21/575; H04L 9/0891; G06F 2221/034

(57) ABSTRACT

Systems and methods include an IHS (Information Handling System) that may include components, such as a system on-chip and a motherboard on which the system on-chip is mounted. The IHS may be configured to store secure boot public keys from facilities in its supply chain and may also be configured to store any boot code that may be used to boot the SOC by facilities in its supply chain. The secure boot public key history and the boot code history may be included in one or more certificates, which may be used to verify supply chain history.

### FIELD

The present disclosure relates generally to Information Handling Systems (IHSs), and relates more particularly to using a signed certificate for boot keys of IHS.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

In an embodiment, a method includes: receiving a component, from a first manufacturing facility, at a second manufacturing facility; evicting a first secure boot public key associated with the first manufacturing facility in favor of a second secure boot public key associated with the second manufacturing facility; booting the component using firmware associated with the second secure boot public key at the second manufacturing facility; generating a signed certificate that includes the first secure boot public key and the second secure boot public key; and storing the signed certificate to secure storage of the component.

In another embodiment, an IHS (Information Handling System) includes: one or more processors; one or more memory devices coupled to the processors, the memory devices storing computer-readable instructions that, upon execution by the processors, cause the IHS to: access a remote access controller (RAC) of the IHS; read a certificate, under control of the RAC, wherein the certificate includes a plurality of public keys; compare the plurality of public keys to a list of allowed public keys; and determine that the IHS has an allowed supply chain or a disallowed supply chain based on comparing the plurality of public keys to the list of allowed public keys.

In another embodiment, a computer-readable storage device having instructions stored thereon, wherein execution of the instructions by one or more processors of the an information handling system (IHS) causes the one or more processors to: boot a processor of a baseboard that has been received from a first manufacturing facility at a second manufacturing facility; evict a first secure boot public key, associated with the first manufacturing facility, in favor of a second secure boot public key, associated with the second manufacturing facility, from the processor; boot the processor using firmware associated with the second secure boot public key at the second manufacturing facility; generate a signed certificate that includes the first secure boot public key and the second secure boot public key; and store the signed certificate to secure storage of the motherboard.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a block diagram illustrating certain components of an example computing cluster having one or more compute sleds, according to some embodiments.

FIG. 2 shows an example of an IHS configured to implement systems and methods described herein for capturing immutable supply chain provenance, according to some embodiments.

FIG. 3 is an illustration of an example supply chain, according to some embodiments.

FIG. 4 is an illustration of an example boot process, which may be performed by an SoC, according to some embodiments.

FIG. 5 is an illustration of an example, which may be performed to create a reviewable and auditable certificate for an IHS, according to some embodiments.

FIG. 6 is an illustration of example method, according to some embodiments.

FIG. 7 is an illustration of an example method, according to some embodiments.

FIG. 8 is an illustration of an example method, according to some embodiments.

FIG. 9 is an illustration of an example method, according to some embodiments.

FIG. 10 is an illustration of an example method, according to some embodiments.

### DETAILED DESCRIPTION

Various embodiments provide systems and methods for capturing immutable supply chain provenance for components of an information handling system (IHS). Looking at a motherboard as an example, the motherboard may include, e.g., a system on-chip (SoC), which includes one or more processor cores. The SoC may be received at a first facility, where that first facility may use one time programming (OTP) techniques to write a first secure boot public key to the SoC. The first secure boot public key may allow the SoC to be booted using boot code that is associated with the first secure boot public key. For instance, the boot code itself may be signed by a private key associated with the secure boot public key. Upon power up, the SoC may read the secure boot public key from OTP, read boot code (including the signature) from flash or other storage, use the secure boot public key to verify the signature, and boot using the code upon signature verification. In some examples, the first facility may not boot the SoC at all. However, by the time that the SoC leaves the first facility, the first secure boot public key may be written to OTP memory of the SoC.

Continuing with the example, the supply chain may move the SoC to a second facility that manufactures a motherboard with the SoC. The second facility may include tools to boot the SoC using the first secure boot public key using boot code that is associated with the first secure boot public key. Assuming that the first secure boot public key verifies the code, then the facility may boot the SoC. During operation, the SoC may generate hashes of the boot code and store those hashes, which may allow a later process to determine that the boot code associated with the first secure boot public key has been used.

The second facility may then evict the first secure boot public key in favor of a second secure boot public key that is associated with the second facility. For instance, the second facility may use the OTP techniques to write the second secure boot public key to the SoC. Following that, the second facility may then boot the SoC using boot code associated with the second secure boot public key. Once booted, the SoC may generate hashes of the boot code and store those hashes as well. At this point, the SoC stores hashes of both the first boot code and the second boot code.

There may be other links in the supply chain. For instance, a third facility may serve as a final manufacturing facility, which receives the motherboard as well as other components and assembles an IHS ready for shipment to an end-user. The third facility may boot the SoC using the second secure boot public key and then evict the second secure boot public key in favor of a third secure boot public key that is associated with boot code of the third facility. The third facility may then boot the SoC using boot code associated with the third secure boot public key. Once booted, the SoC may then generate hashes of the third boot code and store the hashes so that the SoC includes hashes of both the first boot code, the second boot code, and the third boot code.

At this point, the SoC OTP memory may have the first, the second, and the third secure boot public keys written to it. The SoC may also store indications (e.g., hashes) of the first, the second, and the third boot code.

The third facility may include a certificate authority that may create one or more certificates, where those certificates may also indicate points in the supply chain. For instance, the third facility may perform a hardware inventory of the IHS and create a certificate that has both the hardware inventory and the first, second, and the third secure boot public keys. The certificate authority may sign the certificate. For instance, the certificate may be part of a secure component verification (SCV) process. Similarly, the third facility may perform a code inventory of the IHS and create an additional certificate that has the code inventory as well as the hashes from the secure storage. The certificate authority (or another certificate authority) may then sign the additional certificate. Both certificates may be stored to secure storage of the IHS, such as secure storage of the SoC, secure storage of a remote access controller of the IHS, and/or the like. The third facility (or another facility) may also keep copies of the certificates.

In this example, the first certificate may be used to determine supply chain provenance. This is because each of the secure boot public keys may be associated with its particular facility. Thus, the first certificate provides information as to each of the facilities at which the SoC was processed. Similarly, the second certificate may also be used to determine supply chain provenance because each different boot code is associated with a respective facility.

Various embodiments may include potential advantages. For instance, some end-users (e.g., end-users) may have restrictions as to jurisdictions in a supply chain. For instance, one end-user may be subject to policies that prohibit the use of an IHS that has a component from country X. The end-user may inspect one or both certificates to determine which facilities have processed the SoC. The end-user may then advantageously accept delivery of the IHS or reject delivery of the IHS depending on whether the information in one or both certificates complies with their policies.

Furthermore, various embodiments may increase security of an IHS having multiple facilities in its supply chain. Specifically, the final assembly facility may inspect the secure storage and/or the OTP memory of a component (e.g., an SoC) to determine that only approved secure boot public keys and approved code have been used at each step of the supply chain. The final assembly facility may thus audit the boot code from prior facilities to ensure compliance with security protocols.

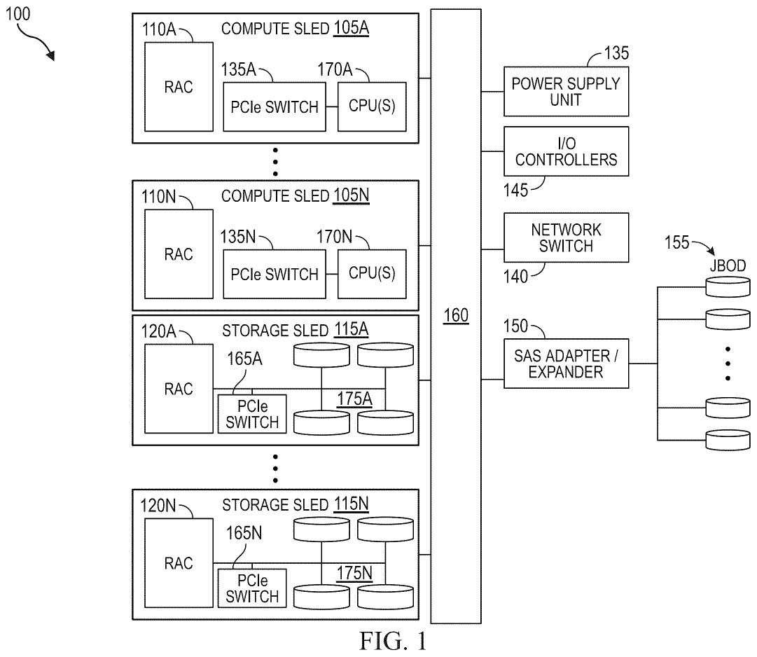

FIG. 1 is a block diagram illustrating certain components of a computing cluster 100 comprising one or more compute sleds 105a-n and one or more storage sleds 115a-n that may be configured to implement the systems and methods described herein for capturing immutable supply chain provenance. Embodiments of computing cluster 100 may include a wide variety of different hardware configurations. Such variations in hardware configuration may result from computing cluster 100 being factory configured to include components specified by an end-user that has contracted for manufacture, provisioning and delivery of the computing cluster 100. Configured in this manner, a computing cluster 100 may be tasked as a single entity that combines the capabilities of the sleds 105a-n, sleds 115a-n and/or other hardware that is included in the computing cluster 100, such as network switches 140 and power supplies 135.

All of the hardware components of the computing cluster 100 may be installed within a rack 100 may include one or more slots that each receive an individual sled (that may be additionally or alternatively referred to as a server, node and/or blade), such as compute sleds 105a-n and storage sleds 115a-n. A rack may support a variety of different numbers, sizes (e.g., 1RU, 2RU) and physical configurations of slots. Computing cluster 100 embodiments may support additional types of sleds that may be installed within a rack and provide various types of storage and/or processing capabilities. Sleds may be individually installed and removed from a rack, thus allowing the computing and storage capabilities of a rack, and thus of a computing cluster 100, to be reconfigured, in many cases without affecting the operation of the other hardware installed in the rack.

The modular architecture provided by the rack allows for certain resources, such as cooling, power and network bandwidth, to be shared by the compute sleds 105a-n and storage sleds 115a-n or other hardware installed in the rack, thus providing efficiency improvements and supporting greater computational loads. Rack may provide all or part of the cooling utilized by sleds 105a-n, 115a-n of a computing cluster 100. For airflow cooling, a rack may include one or more banks of cooling fans that may be operated to ventilate heated air from within the hardware that is installed within the rack. In some embodiments, rack may include liquid cooling manifolds that can be connected to IHSs or other hardware in providing these components with liquid cooling capabilities.

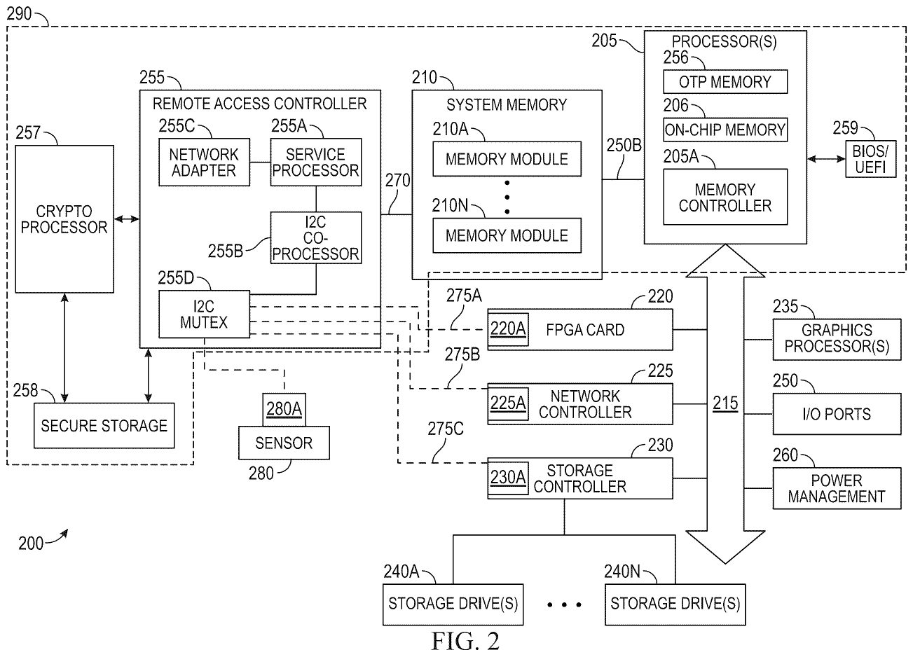

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n may be configured with hardware and software that provide leading-edge computational capabilities. Accordingly, services provided using such computing capabilities are typically provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications by compute sled 105a-n. Remote access controllers 110a-n may collect various types of sensor data, such as collecting temperature sensor readings that are used in support of airflow cooling of the sleds 105a-n, 115a-n. In addition, each remote access controller 110a-n may implement various monitoring and administrative functions related to compute sleds 105a-n that utilize sideband bus connections with various internal components of the respective compute sleds 105a-n.

In some embodiments, each compute sled 105a-n installed in chassis 100 may be uniquely identified based on a code or other identifier that may be permanently encoded in a non-volatile memory of a respective compute sled 105a-n by its manufacturer. As described below, during a provisioning phase of the factory assembly of chassis 100, a signed certificate that specifies the hardware included in a computing cluster 100, such as through such identifiers of compute sleds 105a-n that may be stored in a non-volatile memory accessed by a remote access controller 110a-n of a compute sled 105a-n. Using this signed certificate, an end-user may validate that the hardware components of computing cluster 100 are the same components that were manufactured and provisioned for the end-user. An example of a signed certificate may include one that conforms to SCV procedures, though the scope of implementations may include any type of signed certificate to allow for validation of hardware components and/or software components.

Implementing computing clusters 100 that span multiple processing components (e.g., 105a-n, 115a-n) may be aided by high-speed data links between these processing components, such as PCIe connections that form one or more distinct PCIe switch fabrics 160 that may implemented by network switches 140 and PCIe switches 135a-n, 165a-n installed in the IHSs 105a-n, 115a-n that are members of the computing cluster 100. These high-speed data links may be used to support software that operates spanning multiple processing, networking and storage components of a computing cluster 100. In embodiments, a computing cluster 100 may be tasked and operated as a single component, without regard to the individual hardware components that are members of the computing cluster 100. As described in additional detail below, in embodiments, the computing cluster 100 may implement procedures for identification, and thus tasking, of the computing cluster by other computing systems.

As illustrated, computing cluster 100 may also include one or more storage sleds 115a-n that may be installed within one or more slots of a rack, in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. As illustrated, each storage sled 115a-n includes a remote access controller (RAC) 120a-n provides capabilities for remote monitoring and management of respective storage sleds 115a-n. In some embodiments, each of the storage sleds 115a-n may include a PCIe switch 165a-n for use in coupling the sleds to a switch fabric 160, by which the storage sleds may interface with other members of the computing cluster 100. In some embodiments, each storage sled 115a-n may be uniquely identified based on a code or other identifier that may be permanently encoded in a non-volatile memory of the respective storage sled 115a-n by its manufacturer.

As illustrated, the computing cluster 100 of FIG. 1 includes a network switch 140 that may provide network access to the sleds 105a-n, 115a-n of the cluster. Network switch 140 may include various switches, adapters, controllers and couplings used to connect computing cluster 100 to a network and/or to local IHSs, such as another computing cluster 100 according to embodiments. In some embodiments, a network switch 140 may be uniquely identified based on a code or other identifier that may be permanently encoded in a non-volatile memory of the network switch 140 by its manufacturer. Whereas the illustrated embodiment of FIG. 1 includes a single network switch in a computing cluster 100, different embodiments may operate using different numbers of network switches.

In some embodiments, network switch 140 may be a PCIe switch 265a-b that implements switch fabric 160 and operates as an I/O controller for PCIe communications, such as TLPs (Transaction Layer Packets), that are transmitted between the hardware components (e.g., compute sleds 105a-n and storage sleds 115a-n) that are members of the same computing cluster 100. In addition to serving as I/O controllers that route PCIe traffic, a PCIe network switch 140 includes switching logic that can be used to expand the number of PCIe connections that are supported in the switch fabric 160. For instance, a PCIe network switch 140 may multiply the number of PCIe lanes available via the switch fabric 160. Such capabilities may be utilized in establishing secure channels through which the members of the computing cluster 100 may securely interoperate in collective cluster management operations, such as support for a unified identification, such as a cluster ID, used for tasking and operating the computing cluster 100 as a single entity, and thus without regard or knowledge of the hardware components that are members of the computing cluster.

In some embodiments, computing cluster 100 may include one or more power supply units 135 that provides the components of the computing cluster with various levels of DC power from an AC power source or from power delivered via a power system that may be provided by a rack within which the computing cluster 100 is installed. In certain embodiments, power supply unit 135 may be implemented within a sled that may provide the computing cluster 100 with multiple redundant, hot-swappable power supply units. In some embodiments, a power supply unit 135 may be uniquely identified based on a code or other identifier that may be permanently encoded in a non-volatile memory of the power supply unit 135 by its manufacturer.

In addition to the data storage capabilities provided by storage sleds 115a-n, computing cluster 100 include other storage resources that may be installed within a rack housing the computing cluster 100, such as within a storage blade. In certain scenarios, such storage resources 155 may be accessed via a SAS expander 150 that is coupled to the switch fabric 160 of the computing cluster 100. The SAS expander 150 may support connections to a number of JBOD (Just a Bunch Of Disks) storage drives 155 that may be configured and managed individually and without implementing data redundancy across the various drives 155. In some embodiments, a SAS expander 150 and storage drive 155 may be uniquely identified based on a code or other identifier that may be permanently encoded in a non-volatile memory of the SAS expander 150 or storage drive 155 by its respective manufacturer.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for capturing immutable supply chain provenance. It should be appreciated that although the embodiments described herein may describe an IHS that is a compute sled or similar computing component that may be deployed within slots of rack, other embodiments may be utilized with other types of IHSs that may also be members of a computing cluster 100 according to embodiments. In the illustrative embodiment of FIG. 2, IHS 200 may be a computing component, such as compute sled 105a-n or other type of server, such as an 1RU server installed within a 2RU chassis, that is configured to share infrastructure resources provided by a rack.

As described, an IHS 200 may be assembled and provisioned according to specifications provided by an end-user. The IHS 200 of FIG. 2 may be a compute sled, such as compute sleds 105a-n of FIG. 1, that may be installed within a rack in a data center. Installed in this manner, IHS 200 may utilize shared power, network and cooling resources provided by the rack. Embodiments of IHS 200 may include a wide variety of different hardware configurations. Such variations in hardware configuration may result from IHS 200 being factory assembled to include components specified by an end-user that has contracted for manufacture and delivery of IHS 200. IHS 200 may include capabilities that allow an end-user to validate that the hardware components of IHS 200 are the same hardware components that were installed at the factory during its manufacture, where these validations of the IHS hardware may be initially completed using a factory-provisioned inventory certificate. IHS 200 may include capabilities that allow an end-user to validate the hardware during initialization of the IHS 200 as being the same factory installed and provisioned hardware that was supplied to the end-user.

IHS 200 may include a baseboard 290 (e.g., a motherboard), which includes in this example remote access controller 255, secure storage 258, system memory 210, processors 205, and cryptographic processor 257. Of course, a baseboard may be manufactured to include any appropriate components disposed thereon, such as may be more or fewer than are illustrated in FIG. 2. Further, in another example, the processors 205 as well as the graphics processor 235 (and perhaps other components, such as a modem, additional memory) may be implemented as an SoC and disposed upon motherboard 290.

In one example, OTP memory 256 may include a fuse memory or other appropriate one-time programmable component. The OTP memory 256 may be written to by, e.g., an external tool. Furthermore, OTP memory 256 may be read by either or both of processors 205 and RAC 255. On-chip memory 206 may include non-volatile memory, such as RAM and/or registers. In some examples, memory 206 may be protected using encryption, such as being encrypted using a private key that is stored to OTP memory 256. Secure storage 258 may include any appropriate secure storage, such as a trusted platform module (TPM), which includes a random-access memory (RAM) and hardware-based security to provide storage for cryptographic keys, passwords, and certificates. Another example of a component for secure storage 258 may include a software guard extension (SG X), which allows for the creation of private regions of RAM that are protected from processes and/or the operating system. Of course, secure storage 258 may be implemented using any appropriate technology. A feature of secure storage 258 is that it may only be read by certain components and/or processes. In one example, secure storage 258 may be configured so that it may only be read by RAC 255, thereby being protected from the operating system running on the processors 205. Secure storage 258 may also be encrypted or have other security features so that it may not be read by malicious users. In another example, secure storage 258 may include multiple components, such as one component that may be configured to be read by RAC 255 and another component that may be configured to be read by processors 205.

IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications. In some embodiments, each of the processors 205 may be uniquely identified based on a code or other identifier that may be permanently encoded in a respective processor 205 by its manufacturer. Embodiments support validation of processors 205 as being the same processors that were installed at the factory during the manufacture of IHS 200.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b. The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may include multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory. In some embodiments, each of the memory modules 210a-n may be uniquely identified based on a code or other identifier that may be permanently encoded in a respective memory module 210a-n by its manufacturer. As described below, embodiments support validation of memory modules 210a-n as being the same memory modules that were installed at the factory during the manufacture of IHS 200.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources and/or other peripheral components.

As illustrated, IHS 200 may include one or more FPGA (Field-Programmable Gate Array) cards 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of such logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a. In some embodiments, each of the FPGA cards 220 installed in IHS 200 may be uniquely identified based on a code or other identifier that may be permanently encoded in the FPGA card 220 by its manufacturer. As described below, embodiments support validation of FPGA card 220 as being the same FPGA card that was installed at the factory during the manufacture of IHS 200.

Processor(s) 205 may also be coupled to one or more network controllers 225 via in-band bus 215, such as provided by a Network Interface Controller (NIC) that allows the IHS 200 to communicate via an external network, such as the Internet or a LAN. In some embodiments, network controllers 225 may include a replaceable expansion card or adapter that is coupled to a motherboard connector of IHS 200. In some embodiments, network controllers 225 may be uniquely identified based on a code or other identifier, such as a MAC address, that may be permanently encoded in a non-volatile memory of the network controller by its manufacturer. As described below, embodiments support validation of a network controller 225 as being the same network controller that was installed at the factory during the manufacture of IHS 200, or as being a trusted network controller installed by the end-user. In some embodiments, a network controller 225 may be a PCIe switch, such as PCIe switches 165a-n described in computing cluster 100, while in other embodiments, the network controllers 255 of IHS 100 may include both a PCIe switch and a separate ethernet network controller. As described, a PCIe switch may be used by the IHS 200 to interface with other members of a computing cluster 100 via a switch fabric 160, such as the use of a selected PCIe lane for cluster management communications used in the collective management of the computing cluster, where the IHS 200 may be designated leader or may be a participant in the collective management of the computing cluster 100.

IHS 200 may include one or more storage controllers 230 that may be utilized to access storage drives 240a-n that are accessible via a rack in which IHS 100 is installed. Storage controller 230 may provide support for RAID (Redundant Array of Independent Disks) configurations of logical and physical storage drives 240a-n. In some embodiments, storage controller 230 may be an HBA (Host Bus Adapter) that provide more limited capabilities in accessing physical storage drives 240a-n. In some embodiments, storage drives 240a-n may be replaceable, hot-swappable storage devices that are installed within bays provided by the chassis in which IHS 200 is installed. In embodiments where storage drives 240a-n are hot-swappable devices that are received by bays of chassis, the storage drives 240a-n may be coupled to IHS 200 via couplings between the bays of the chassis and a midplane of IHS 200. In some embodiments storage drives 240a-n may also be accessed by other IHSs that are also installed within the same chassis as IHS 100. Storage drives 240a-n may include SAS (Serial Attached SCSI) magnetic disk drives, SATA (Serial Advanced Technology Attachment) magnetic disk drives, solid-state drives (SSDs) and other types of storage drives in various combinations. In some embodiments, each individual storage controller 230 and storage drive 240a-n may be uniquely identified based on a code or other identifier that may be permanently encoded in a non-volatile memory of the component by its manufacturer. As described below, embodiments support validation of storage controller 230 and storage drives 240a-n as being the same storage controller and storage drives that were installed at the factory during the manufacture of IHS 200.

A variety of additional components may be coupled to processor(s) 205 via in-band bus 215. For instance, processor(s) 205 may also be coupled to a power management unit 260 that may interface with the power system unit 135 of the computing cluster 100 in which an IHS may be a member. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255. In some embodiments, components such as power management unit 260 and graphics processor 235 may also be uniquely identified based on a code or other identifier that may be permanently encoded in a non-volatile memory of these components by their respective manufacturer. As described below, embodiments support validation of these components as being components that were installed at the factory during the manufacture of IHS 200.

In certain embodiments, IHS 200 may operate using a BIOS (Basic Input/Output System) 259 that may be stored in a non-volatile memory (e.g., flash EEPROM) accessible by the processor(s) 205. In some embodiments, the memory that stores the BIOS 259 may be a separate chip from any of processors 205. The BIOS 259 may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by the BIOS 259 may be implemented, in full or in part, by the remote access controller 255. As described in additional detail below, in some embodiments, BIOS 259 may be configured to identify hardware components that are detected as being currently installed in IHS 200. In such instances, the BIOS may support queries that provide the described unique identifiers that have been associated with each of these detected hardware components by their respective manufacturers.

Furthermore, BIOS 259 illustrates an example of boot code, which may be associated with a secure boot public key. Boot code and a secure boot public key are described in more detail below.

In some embodiments, IHS 200 may include a TPM (Trusted Platform Module) that may include various registers, such as platform configuration registers, and secure storage, such as an NVRAM (Non-Volatile Random-Access Memory). As noted above, the TPM may be implemented by secure storage 258, at least in part. The TPM may also include the cryptographic processor 257 that supports various cryptographic capabilities. In IHS embodiments that include a TPM, a pre-boot process implemented by the cryptographic processor 257 may utilize its cryptographic capabilities to calculate hash values that are based on software and/or firmware instructions utilized by certain core components of IHS, such as the BIOS 259 and boot loader of IHS 200. These calculated hash values may then be compared against reference hash values that were previously stored in a secure non-volatile memory 258 of the IHS, such as during factory provisioning of IHS 200. In this manner, a cryptographic processor 257 may establish a root of trust that includes core components of IHS 200 that are validated as operating using instructions that originate from a trusted source.

As described, IHS 200 may include a remote access controller 255 that supports remote management of IHS 200 and of various internal components of IHS 200. In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS 259, including launching the operating system of the IHS 200, may be implemented by the remote access controller 255. In some embodiments, the remote access controller 255 may perform various functions to verify the integrity of the IHS 200 and its hardware components prior to initialization of the operating system of IHS 200 (i.e., in a bare-metal state). In some embodiments, certain operations of the remote access controller 225, such as the described inventory certificate generation and validation operations, may operate using validated instructions, and thus within the root of trust of IHS 200.

As part of the management capabilities of a remote access controller 255, embodiments may include capabilities for detecting the addition or removal of a hardware device from a computing cluster of which IHS 200 is a member. In some embodiments, the remote access controller 255 may interface with remote management tools that may provide notifications of component being added or removed from a computing cluster 100. In some embodiments, sideband communication capabilities of the remote access controller 255 may be utilized in detecting the coupling of components to a computing cluster, such as the detection of broadcasts by new components on management busses monitored by the remote access controller 255.

In some embodiments, remote access controller 255 may be uniquely identified based on a code or other identifier that may be permanently encoded in a non-volatile memory of the remote access controller 255 by its manufacturer. Some embodiments may support validation of remote access controller 255 as being the same controller that was installed at the factory during the manufacture of IHS 200. Also, during a provisioning phase of the factory assembly of IHS 200, a signed certificate that specifies factory installed hardware components of IHS 200 that were installed during manufacture of the IHS 200 may be stored in secure storage 258, which may be accessed by remote access controller 255. Using this signed inventory certificate stored by the remote access controller 255, an end-user may validate that the detected hardware components of IHS 200 are the same hardware components that were installed at the factory during manufacture of IHS 200.

In support of the capabilities for validating the detected hardware components of IHS 200 against the inventory information that is specified in a signed inventory certificate, remote access controller 255 may include various cryptographic capabilities. For instance, remote access controller 255 may include capabilities for key generation such that remote access controller may generate keypairs that include a public key and a corresponding private key. Using generated keypairs, remote access controller 255 may digitally sign inventory information collected during the factory assembly of IHS 200 such that the integrity of this signed inventory information may be validated at a later time using the public key by an end-user that has purchased IHS 200. Using these cryptographic capabilities of the remote access controller 255, the factory installed inventory information that is included in an inventory certificate may be anchored to a specific remote access controller 255, since the keypair used to sign the inventory information is signed using the private key that is generated and maintained by the remote access controller 255.

In some embodiments, the cryptographic capabilities of remote access controller 255 may also include safeguards for encrypting any private keys that are generated by the remote access controller and further anchoring them to components within the root of trust of IHS 200. For instance, a remote access controller 255 may include capabilities for accessing hardware root key (HRK) capabilities of IHS 200, such as for encrypting the private key of the keypair generated by the remote access controller. In some embodiments, the HRK may include a root key that is programmed into a fuse bank, or other immutable memory such as OTP memory 256, during factory provisioning of IHS 200.

The root key may be provided by a factory certificate authority. By encrypting a private key using the hardware root key of IHS 200, the hardware inventory information that is signed using this private key is further anchored to the root of trust of IHS 200. If a root of trust cannot be established through validation of the remote access controller cryptographic functions that are used to access the hardware root key, the private key used to sign inventory information cannot be retrieved. In some embodiments, the private key that is encrypted by the remote access controller using the HRK may be stored to a secure storage 258. In one example, secure storage 258 may be implemented as a replay protected memory block (RPMB) that is accessed using security protocols that require commands accessing the RPMB to be digitally signed using a symmetric key and that include a nonce or other such value that prevents use of commands in replay attacks. Stored to an RPMG, the encrypted private key can only be retrieved by a component within the root of trust of IHS 200, such as the remote access controller 255.

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as non-standard hardware 220, network controller 225 and storage controller 230, are coupled to the IHS processor(s) 205 via an in-line bus 215, such as a PCIe root complex, that is separate from the I2C sideband bus connections 275a-d used for device management. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280. In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

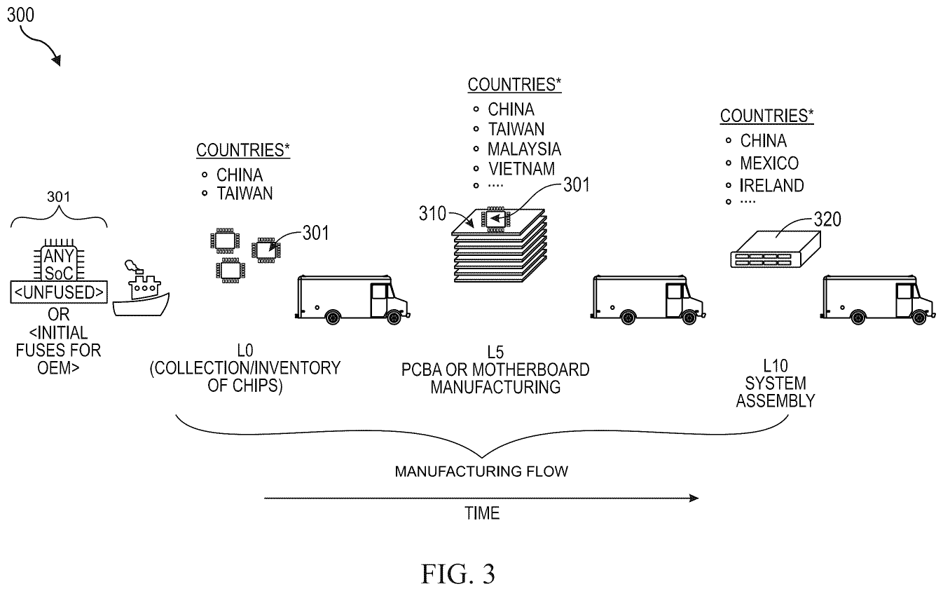

FIG. 3 is an illustration of an example supply chain 300, according to some embodiments. It is understood that some supply chains may have more or fewer facilities, and the scope of implementations may be adapted to any size supply chain.

The reference L0 represents a first facility in the supply chain 300. The facility L0 may receive manufactured SoCs, such as SoC 301, or may manufacture SoCs. The SoCs may be pre-programmed with a first secure boot public key (e.g., in OTP memory, such as OTP memory 256) or may come with an empty OTP memory. In one example, the facility L0 may receive SoCs and may perform an initial boot operation. For instance, if a given SoC already has a first secure boot public key in its OTP memory, then facility L0 may place the SoC in a testing apparatus, which may cause the SoC to boot using first boot code associated with the first secure boot public key. If the SoC does not have the first secure boot public key in its OTP memory, then facility L0 may fuse the first secure boot public key to the OTP memory and then perform the boot process. At this point, the SoC may have the first secure boot public key written to its OTP memory, and the SoC may also have hashes of the boot code stored in its memory 206.

In some examples, facility L0 may not boot SoC 301 or run any firmware. Rather, the first true boot and execution of firmware may happen at facility L5.

Facility L0 may be located anywhere in the world. In the example of FIG. 3, facility L0 may be located in China or Taiwan, though the scope of implementations may include other countries as well.

The reference L5 represents a second facility in the supply chain 300. In this example, the facility L5 may be located anywhere in the world, such as China, Taiwan, Malaysia, Vietnam, or the like.

In this example, facility L5 may receive SoC 301 from L0 and then manufacture a motherboard 310 by, in part, mounting SoC 301 upon motherboard 310. For instance, facility L5 may manufacture motherboard 310 by electrically coupling pins of SoC 301 to electrical connectors upon a printed circuit board (PCB).

As part of the process, facility L5 may boot SoC 301 by using the first secure boot public key (from facility L0). Facility L5 may then reprogram SoC 301 to store a second secure boot public key in the OTP memory of SoC 301. This process may be referred to as transfer of root of trust ownership, and it includes evicting the first secure boot public key in favor of the second secure boot public key. The second secure boot public key may be associated with boot code of the facility L5. Once facility L5 has evicted the first secure boot public key in favor of the second secure boot public key, facility L5 may then boot SoC 301 using boot code of the facility L5. During the boot process, hashes of the boot code of the facility L5 may be stored in the memory 206 of SoC 301. In another example, memory 206 may be limited so that it is unable to store multiple hashes. In such a case, the SoC may move a previous hash (e.g., the hash of the L0 boot code) to secure storage 258 before overwriting the previous hash with the new hash (e.g., the hash of the L5 boot code) in memory 206. Subsequent boot operations may include moving the boot code hash contents to secure memory 258, so that memory 258 may store a comprehensive boot history. Thus, secure storage 258 may act as an extension of memory 206, and memory 206 and secure storage 258 may both be considered secure storage for the purpose of storing boot code hashes.

At this point in the supply chain, the OTP memory of SoC 301 may include the first secure boot public key as well as the second secure boot public key. The memory 206 of SoC 301 (and/or secure memory 258) may include hashes for both of the L0 boot code and the L5 boot code.

The facility L5 may then ship the manufactured motherboard 310 to facility L10. In this example, facility L10 may be in China, Mexico, Ireland, or the like. Further in this example, facility L10 is a final assembly or system assembly facility. For instance, the facility L10 may implement the motherboard 310 into an IHS 320 for delivery to an end-user, where the IHS 320 may include, e.g., a sled, such as discussed above with respect to FIG. 1. A sled may be a compute server, storage server, a network component, and/or the like. In another example, the IHS 320 may include a laptop computer, desktop computer, tablet computer, or the like.

The system assembly at facility L10 may also include implementing other components within the system, such as the components of FIG. 2 that are not part of the motherboard (290 of FIG. 2). Examples of other components may include network controllers, storage drives, power supplies, and the like. System assembly at facility L10 may also include installing firmware and/or software for use by the various components.

Furthermore, the system assembly at facility L10 may include the facility L10 evicting the L5 secure boot public key in favor of a third secure boot public key of L10. The facility L10 may also install boot code (e.g., in BIOS or UEFI), where that boot code is associated with the secure boot public key of L10. In some examples, the facility L10 may include multiple secure boot public keys and multiple boot codes available to use, where a given product may be associated with a single, respective secure boot public key and a single, respective boot code. In other words, the system assembly at facility L10 may include the secure boot public key of L10 being specific to L10 as well as being specific to a particular product that is being assembled at L10.

At this point in the supply chain, the SoC 301 has the first secure boot public key, the second secure boot public key, and the third secure boot public key written to its OTP memory. The SoC 301 may also have hashes of the L0 boot code, the L5 boot code, and the L10 boot code stored to its memory 206. As noted above, the secure memory 258 may include the hashes of the L0 boot code, the L5 boot code, and the L10 boot code in some instances, with SoC 301 only including the most current hash.

As noted above, the various hardware components may have unique identifiers. A tool at facility L10 may be configured to perform a hardware inventory. Performing the hardware inventory may also include reading the OTP memory of the SoC 301 and including the contents of the OTP memory in the hardware inventory. Therefore, the hardware inventory may include the first, second, and third secure boot public keys. The facility L10 may include a certificate authority that signs a certificate, where the certificate includes the hardware inventory. Thus, an end-user may access and review the signed certificate to determine which secure boot public keys and, as a result, determine which countries are included in the supply chain. This certificate may conform to any appropriate format, such as SCV.

The facility L10 may also be configured to generate a code inventory, where each different portion of code (e.g., firmware) in the IHS 320 may have a unique identifier, similar to a unique identifier of each of the different hardware components. The facility L10 may include within the code inventory the hashes of the first, second, and third boot codes, and the facility L10 may then sign the certificate. This second certificate may also be accessed and reviewed by the end-user to determine which boot codes were used and, as a result, determine which countries are included in the supply chain. The certificate may conform to any appropriate format, such as reference integrity manifest (RIM).

Facility L10 may store either or both of the signed certificates in any appropriate component, such as secure storage (258 of FIG. 2).

In one example, the facility L10 may include a database of the different secure boot public keys, the corresponding boot codes, and may associate the secure boot public keys and their corresponding boot codes with specific facilities. The facility L10 may make the database at least partially available to end-users so that end-users may review and audit the certificates discussed above against the contents of the database.

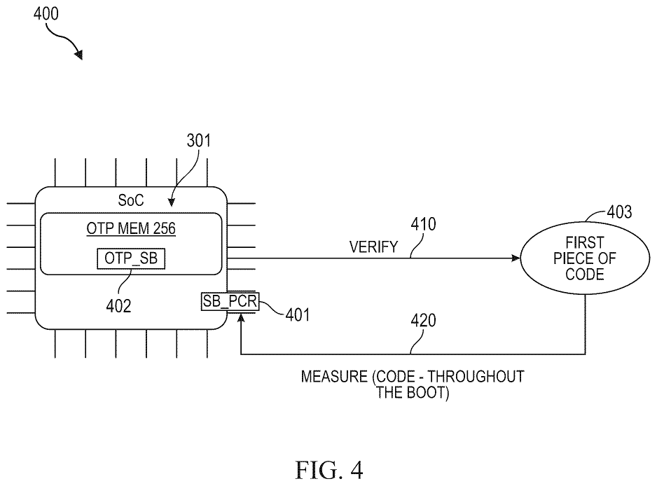

FIG. 4 is an illustration of an example boot process 400, which may be performed by SoC 301, according to some embodiments.

SoC 301 includes OTP memory 256. OTP memory 256 may include, among other things, a set of bits 402 (OTP secure boor or “OTP_SB”), which may be used to store secure boot public keys. Registers 401 (SB_PCR) may be included in on-chip memory 206 (FIG. 2) in some examples.

Some facilities may have the ability to write to the OTP memory 256. For instance, OTP memory 256 may be protected by encryption or other mechanisms so that only specific tools in specific facilities may write to OTP memory 256.

In this example, SoC 301 is configured so that it will not allow boot code to run unless that boot code is signed by a private that is part of the public/private key pair that includes the public key stored in bits 402. When a facility or an end-user attempts to boot SoC 301, SoC 301 is configured to read the secure boot public key from bits 402 and then to verify a signature of code 403. For instance, the code 403 may include a signature. SoC 301 uses the secure boot public key to decrypt the signature of the code 403. If the secure boot public key successfully decrypts the signature (e.g., verifies the signature), then SoC 301 may continue with the boot process 400. If the signature is not verified, then SoC 301 may discontinue the boot process 400.

Assuming that there the signature is verified, and boot process 400 continues, then SoC 301 may execute the code 403. SoC 301 is configured to create a hash from code 403 during the boot process 400. SoC 301 may execute the code 403 portion-by-portion and may create the hash portion-by-portion according to a hashing algorithm. As SoC 301 executes the code 403, SoC 301 may store the hashes to registers 401. Once the boot code has been executed, SoC 301 will have stored an aggregated hash to registers 401, where that aggregated hash may be read and verified later to indicate which boot code has been executed. As noted above, the secure memory 258 may include the hashes of the L0 boot code, the L5 boot code, and the L10 boot code in some instances, with SoC 301 only including the most current hash.

One example eviction process may include the eviction process performed at facility L10 to evict the secure boot public key of facility L5. For instance, when facility L10 receives motherboard 310, it may use the L5 secure boot public key and the L5 boot code to boot SoC 301. Once SoC 301 has been booted, then facility L10 may have access to update bits 402 within OTP memory 256. For instance, facility L10 may write its L10 secure boot public key to registers 401. At this point, registers 401 may include both the L5 secure boot public key and the L10 secure boot public key. Various embodiments may use any technique to distinguish a current key from an old key, such as serial writing where a last-written key is considered the current key and other keys are considered old. In another example, OTP memory 256 may include a data structure that includes one or more bits that may be written using OTP techniques to indicate which one of multiple secure boot public keys is current. SoC 301 may be configured to only boot using a current secure boot public key.

Once facility L10 has written its L10 secure boot public key to bits 402, facility L10 may then re-boot SoC 301. Facility L10 may also provide new code that is signed by a private key associated with the L10 secure boot public key. During re-boot, SoC 301 reads bits 402, extracts the L10 secure boot public key, and verifies the signature of the new boot code with the extracted L10 secure boot public key. Assuming the code is verified, the re-boot process may continue. As a result, the SoC 301 is programmed to only boot using boot code that includes the L10 secure boot public key until the L10 secure boot public key is evicted (if ever). It is conceivable that further manufacturing steps or supply-chain steps (or repair steps) may include eviction in favor of a different secure boot public key.

Of course, this eviction process is only an example, and any appropriate eviction process may be used in various embodiments.

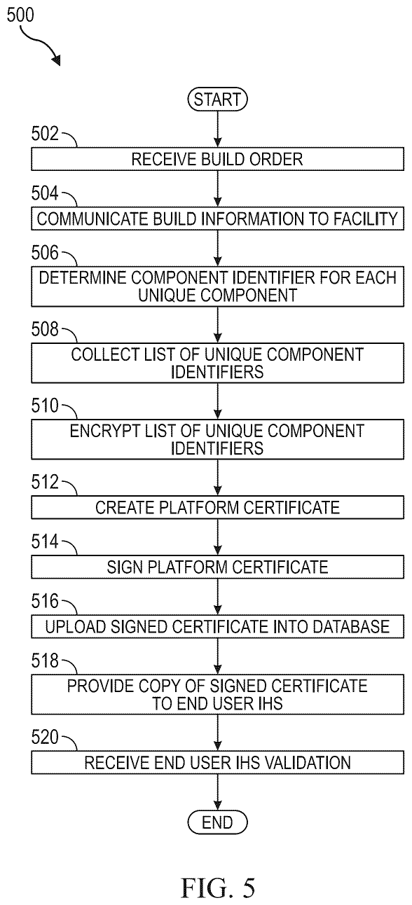

FIG. 5 is an illustration of an example method 500, which may be performed to create a reviewable and auditable certificate for an IHS, according to some embodiments.

At action 502, an order to build IHS 320 is processed. In some embodiments, a build order may be received from an end-user, such as by a user placing an order online. A build order may include desired specifications for IHS 320, such as a hard disc drive (HDD) having a minimum memory, a central processing unit (CPU) or graphics processing unit (GPU) having a minimum processing speed, or some other component or operating parameter. The build order may also include instructions to avoid manufacture in certain countries or to positively identify some countries for manufacture.

Some end-users do not know (or might not be concerned) which components—including which unique components—are installed in IHS 320. For example, a user might specify a memory requirement of 1 TB for a hard disc drive (HDD) and accept any HDD from any vendor that has 1 TB of memory. A manufacturer of IHS 320 may purchase thousands of HDDs from multiple vendors, with each HDD having at least 1 TB of memory. However, variations in relation to power, processing speed, operating temperatures, etc. may occur among HDDs in different batches from the same vendor or different vendors, such that HDDs installed in IHS 320 may have different specifications, performance and service life. To ensure an IHS 320 delivered to an end-user matches the build order and to protect warranty claims, embodiments may track unique components and communicate with an IHS 320 delivered to the end-user to validate that unique components in the delivered IHS 320 match the unique components in the build order.

At action 504, a build order is communicated to the manufacturing facilities (e.g., facilities L0, L5, L10). A manufacturing facility (e.g., facilities L5, L10) may receive unique components from multiple vendors, and multiple manufacturing facilities may receive unique components from multiple vendors. Each vendor may provide information such as operating specifications for a unique component. The information may include a voltage or a range of voltages, an operating temperature or a range of operating temperatures, a processing speed or a range of operating speeds, and other operating parameters.

As noted above, the various hardware components may include unique component identifiers, such as service tags, which may be used in later actions for cryptographic identity. Actions 506-520 may be performed at a final assembly facility, such as L10, as discussed above.

At action 506, as IHS 320 is built, the manufacturing facility may determine a component identifier for each unique component corresponding to IHS 320 being built. Determining a component identifier may include the manufacturing facility scanning a label on each unique component at the action in the manufacturing process in which the unique component is installed in IHS 320.

At action 508, a component tracking system at the L10 facility may collect information about each unique component. In some embodiments, the manufacturing facility may record information about each unique component in a data structure corresponding to IHS 320 being built. The data structure may include a service tag of the IHS 320 being built and the facility where the IHS 320 is being built. Information about a unique component may include the unique identifier, a vendor of the unique component, a date of manufacture of the unique component, one or more operating parameters of the unique component (e.g., voltage requirements, maximum operating temperature and minimum cooling requirements).

In this example, action 508 may further include reading the secure boot public keys from the OTP memory 256 and including those secure boot public keys in the data structure.

At action 510, the facility may encrypt the data structure. At action 512, the facility may create an SCV certificate including the encrypted data structure.

At action 514, a tool at the facility may sign the SCV certificate. In some embodiments, a Hardware Security Module (HSM) of the facility may include a certificate authority that may sign the SCV certificate using a private key of the HSM.

At action 516, the facility may store the signed SCV certificate in a repository associated with the certificate authority for the SCV certificate. For instance, the manufacturing facility may store the signed SCV certificate itself or may have another facility store the signed SCV certificate.

At action 518, the facility may store a copy of the signed SCV certificate to the IHS 320, such as in secure storage 258, which may be accessed by a remote access controller on IHS 320 (e.g., RAC 255).

IHS 320 may be shipped to an end-user for installation. When the end-user powers on IHS 320, at action 520, the facility may receive validation from the end-user IHS 320. In some embodiments, IHS 320 may communicate a copy of the signed SCV certificate to the repository, which may compare the copy of the signed SCV certificate with the signed SCV certificate stored in the repository. If the copy of the signed SCV certificate matches the signed SCV certificate stored in the repository, the facility may verify that the IHS 320 delivered to the end-user matches IHS 320 built by the manufacturing facility. Verification of IHS 320 may be used subsequently to preserve warranty claims.

An SCV certificate may have a format based on a Trusted Computing Group (TCG) platform specification. An SCV certificate may be based on a standard such as X.509 standard. In some examples, an SCV certificate 422 may include certificate information such as a version number, a serial number and a signature algorithm identifier (ID). Of course, the scope of embodiments may use any appropriate format for the certificate, whether one that conforms to an SCV standard or a different format.

FIG. 5 provides a process for creating an SCV certificate for hardware components, where that SCV certificate also indicates secure boot public keys that have been used for booting SoC 301 during the manufacturing process. A similar process may be performed for software and firmware components (e.g., a code inventory). For instance, some or all pieces of code installed in IHS 320 may include unique identifiers, which may be collected in a data structure, encrypted, and a second certificate created and signed. Further in this example, the code inventory data structure may also include the boot code hashes from registers 401. The second certificate, based upon the code inventory, may then also include the boot code hashes. The second certificate may be stored by the facility or another facility and may also be stored to the IHS 320, such as at secure storage 258.

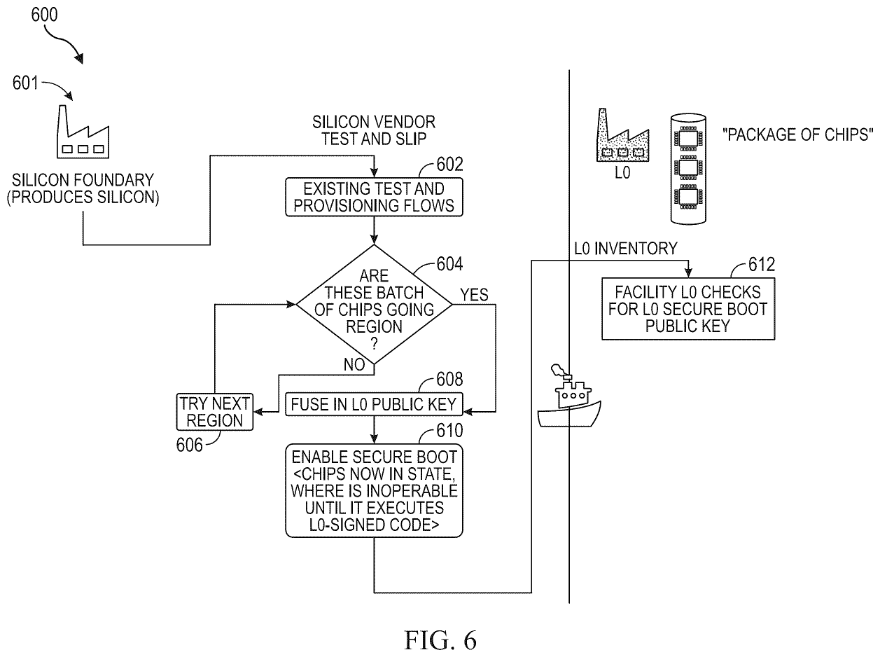

FIG. 6 is an illustration of example method 600, according to some embodiments.

In method 600, a silicon foundry 601 may produce a chip, such as SoC 301. At action 602, the silicon foundry 601 may apply existing test and provisioning flows, such as for quality control. At action 604, the silicon foundry 601 may apply different secure boot public keys based on a destination for a given SoC that it produces. For instance, if the entity associated with the build order (e.g., the entity associated with facility L10) specifies that the secure boot public key associated with region X (a location of facility L0) should be used, then the silicon foundry 601 may write the secure boot public key associated with region X to the OTP memory (e.g., OTP memory 256). At actions 604 and 606, the silicon foundry 601 may determine a region and an appropriate secure boot public key for a given chip.

At action 608, the silicon foundry 601 may write the secure boot public key, as determined by actions 604 and 606. At action 610, the SoC 301 is in a state where secure boot is enabled, as long as the boot code is associated with the secure boot public key, such as the secure boot public key of facility L0.

At action 612, the SoC 301 is shipped to the facility L0, and the facility L0 may then check for the L0 secure boot public key. If the facility L0 determines that the SoC 301 does not have the L0 secure boot public key written, then facility L0 may reject the SoC 301. On the other hand, should the facility L0 determine that the SoC 301 does have the L0 secure boot public key written, then facility L0 may move forward with any further processes at facility L0. For instance, facility L0 may perform different tests, such as verifying a cryptographic hardware identity (e.g., an initial device identifier, IDevID). Facility L0 may or may not boot the SoC 301. In an instance in which facility L0 boots the SoC 301, then hashes of the boot code may be stored to registers 401.

Once facility L0 has completed its processes, then it may transfer the SoC 301 to the next facility. In the examples of FIGS. 3 and 6-8, the next facility is facility L5.

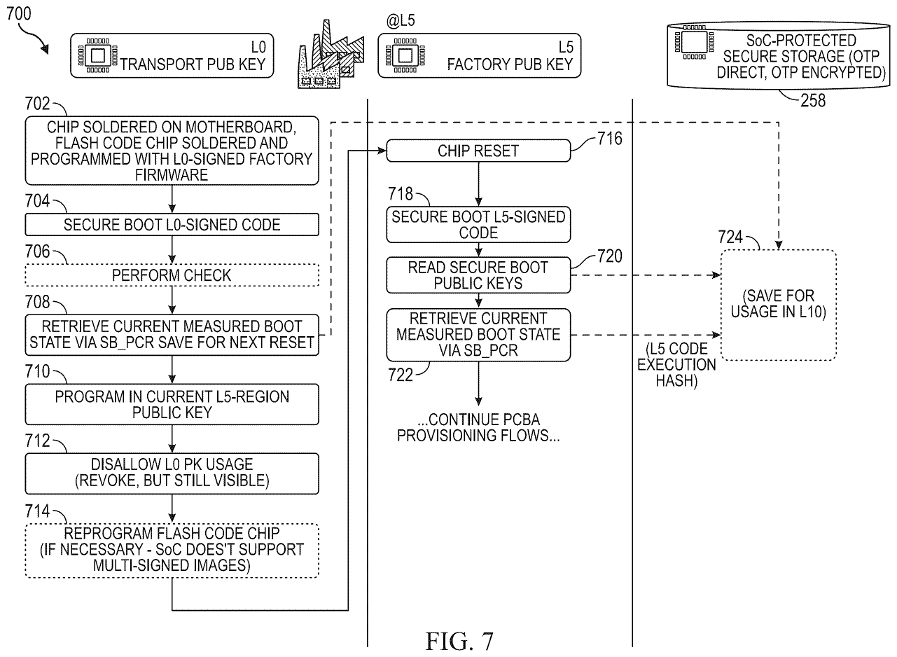

FIG. 7 is an illustration of an example method 700, according to some embodiments. Method 700 may be performed, e.g., by facility L5 as it receives the SoC 301 from facility L0.

At the beginning of method 700, the SoC 301 has the secure boot public key for the facility L0 stored in its OTP memory (e.g., OTP memory 256). In other words, at this point, the SoC 301 is only able to execute boot code that is associated with the secure boot public key for the facility L0.

At action 702, the facility L5 solders the SOC 301 on a motherboard and also solders a flash code chip to the motherboard 310. The flash code chip may be programmed with boot code that is associated with the secure boot public key for the facility L0. For instance, the boot code may include a copy of the L0 secure boot public key and/or the boot code may be signed by a private key associated with the L0 secure boot public key.

At action 704, the facility L5 may boot the SoC 301 using the boot code associated with L0. After the SoC is booted, the facility L5 may perform a check, such as verifying the L0 secure boot public key and for a cryptographic identity of SoC 301 at action 706. At action 708, the facility L5 may retrieve the current measured boot state and save that boot state for the next reset. For instance, saving the measured boot state may include saving one or more hashes of the boot code to the registers 401.

At action 710, the facility L5 may then program the SoC to include the L5 secure boot public key. In one example, the facility L5 may perform a transfer of root of trust ownership to evict the L0 secure boot public key and to write the L5 secure boot public key to the OTP memory 256 in the set of bits 402 (OTP_SP). For instance, the OTP memory 256 may include enough space so that multiple secure boot public keys may be written to it. At this point, the OTP memory 256 may include both the L0 secure boot public key and the L5 secure boot public key, though only the L5 secure boot public key may be allowed for booting at action 712. As noted above, any appropriate technique for eviction may be used. For instance, there may be a data structure in OTP memory 256 that indicates which one of the secure boot public keys is current.

At action 714, the L5 facility may reprogram the flash code chip to include boot code that is associated with the L5 secure boot public key (L5 boot code). For instance, the boot code may include a copy of the L5 secure boot public key and/or may be signed by a private key associated with the L5 secure boot public key. In any event, the SoC may later verify that the boot code is associated with the L5 secure boot public key, such as in the verify action 410 of FIG. 4.

At action 716, the L5 facility may reset the SoC, which may cause the SoC to then boot using the L5 boot code at action 718. At action 720, the L5 facility may read the secure boot public keys from the OTP memory 256. In this example, the L5 facility may read both the L0 secure boot public key (which is written previously) and the L5 secure boot public key (which was written at the L5 facility). At action 724, the L5 facility may cause the secure boot public keys, read at action 720, to be written to the secure storage 258. Action 722, the facility L5 may retrieve the current measured boot state via registers 401, where the measured boot state may include hashes of both the L0 boot code and the L5 boot code. At action 724, the facility L5 may write the measured boot state to the secure storage 258.

Thus, after action 724, the secure storage 258 may include hashes of the L0 boot code and the L5 boot code and may also include the L0 secure boot public key and the L5 secure boot public key. After action 724, the L5 facility may continue with other processes, such as mounting additional components to the motherboard, finishing the motherboard, and shipping the motherboard to facility L10. An example of a motherboard is motherboard 310 of FIG. 3.

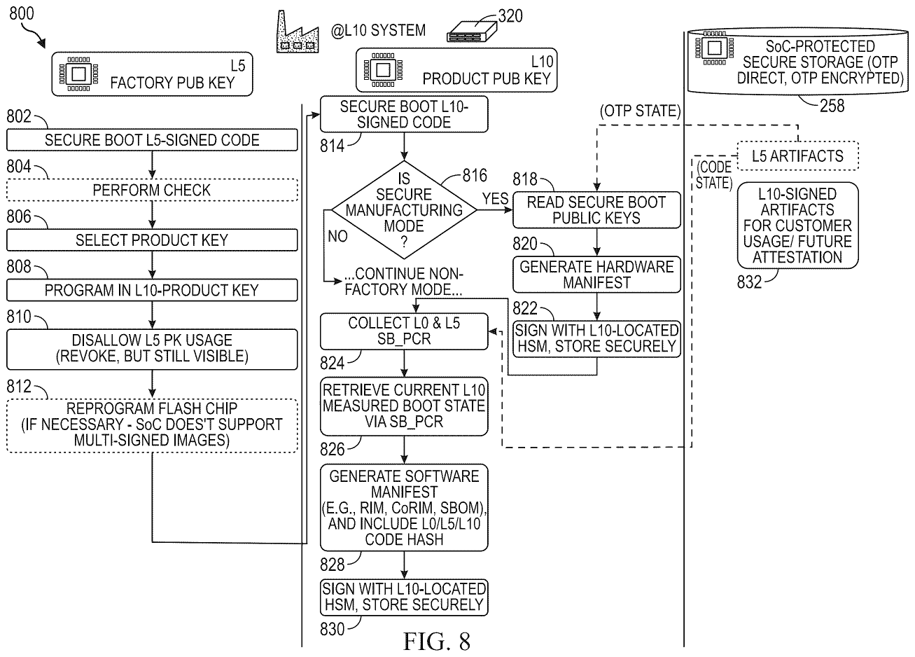

FIG. 8 is an illustration of an example method 800, according to some embodiments. Method 800 may be performed, e.g., by the facility L10 is it receives the motherboard 310 (including the SoC 301) from the L5 facility.

The facility L10 may receive the motherboard 310 from the facility L5 and assemble IHS 320, which includes the motherboard 310. As noted above, the motherboard 310 may include the SoC 301.

At action 802, the facility L10 may use the L5 boot code to boot the SoC 301. Then the L10 facility may perform a check at action 804, where that check may be the same as or similar to the check at action 706. At action 806, the L10 facility may select a product key. For instance, the L10 facility may assemble a multitude of different products, and each one of the different products may be associated with a different secure boot public key. For instance, the motherboard 310 from the L5 facility may go into a compute server, a storage server, a networking device, and/or the like. A build order may specify which product for the motherboard 310 to be assembled into.

Once the L10 facility has selected the appropriate secure boot public key for the product, then at action 808, the L10 facility may program that secure boot public key (the L10 product key) into the OTP memory 256. Action 810 includes disallowing the L5 secure boot public key, such as by evicting the L5 secure boot public key in favor of the L10 product key. At this point, the OTP memory 256 may include the L0 secure boot public key, the L5 secure boot public key, and the L10 product key.

At action 812, the L10 facility may reprogram the flash chip to include a firmware image, including boot code, that is associated with the L10 product key. For instance, the boot code may include a copy of the L10 product key and/or may be signed by a private key associated with the L10 product key.

At action 814, the L10 facility may then reset and re-boot the SoC 301 using the L10 boot code. The SoC 301 may create a hash of the L10 boot code and store it to registers 401 and/or to secure memory 258. The L10 facility may include a nonsecure manufacturing mode and a secured manufacturing mode. In this example, the L10 facility continues with the secure manufacturing mode at actions 810 and 818.

At action 818, the L10 facility may read the secure boot public keys, such as from the OTP memory 256. In some embodiments, the secure boot public keys previously used to boot the SoC 301 may be stored to the secure storage 258 instead of or in addition to being stored in the OTP memory 256. In such an example, the action 818 may include reading the prior secure boot public keys (from L0 and L5) from the secure storage 258 and reading the current secure boot public key (the L10 product key) from the OTP memory 256. In any event, the L10 facility reads the current secure boot public key as well as any prior secure boot public keys that have been used to boot the SoC 301.

At action 820, the L10 facility may generate a hardware manifest (e.g., data structure) and include the L0, L5, and L10 secure boot public keys in the hardware manifest. Action 820 may be similar to action 508 of FIG. 5. That is, the L10 facility may generate the hardware manifest, which includes unique identifiers of the different hardware components as well as the L0, L5, and L10 secure boot public keys.

Action 822 may include creating a hardware certificate, such as an SCV certificate, using the data structure generated at action 820. Action 822 may be the same as or similar to actions 510-516 of FIG. 5. For instance, the certificate may be signed using a private key of the L10 facility (e.g., a private key of an HSM). Action 822 may also include storing the certificate in the secure storage 258, such as illustrated additionally with action 832.

Actions 824 and 826 include reading and collecting the current and prior boot states. For instance, actions 824 and 826 may include reading hashes of the L0, L5, and L10 boot code from registers 401 and/or from the secure storage 258. Action 828 may include generating a software manifest. For instance, the different firmware and software code installed in IHS 320 may each include unique identifiers. The software manifest may include the unique identifiers and/or any useful information regarding the code installed in IHS 320. The software manifest may follow a format, such as RIM, concise RIM (CoRIM), software bill of materials (SBOM), or the like. The software manifest may further include the hashes of the L0, L5, and L10 boot code.

Action 830 may include the HSM of the L 10 facility signing the software manifest, which may be similar to the action 514 of FIG. 5. Action 830 generates a second certificate. Action 830 in combination with action 832 may include storing the second certificate to the secure storage 258.

At this point, the secure storage 258 includes the two different certificates, the first certificate for the hardware and the second certificate for the software. Both certificates may be read and audited by the HSM and/or the end-user. Following assembly at facility L10, the assembled IHS 320 may be shipped to an end-user.

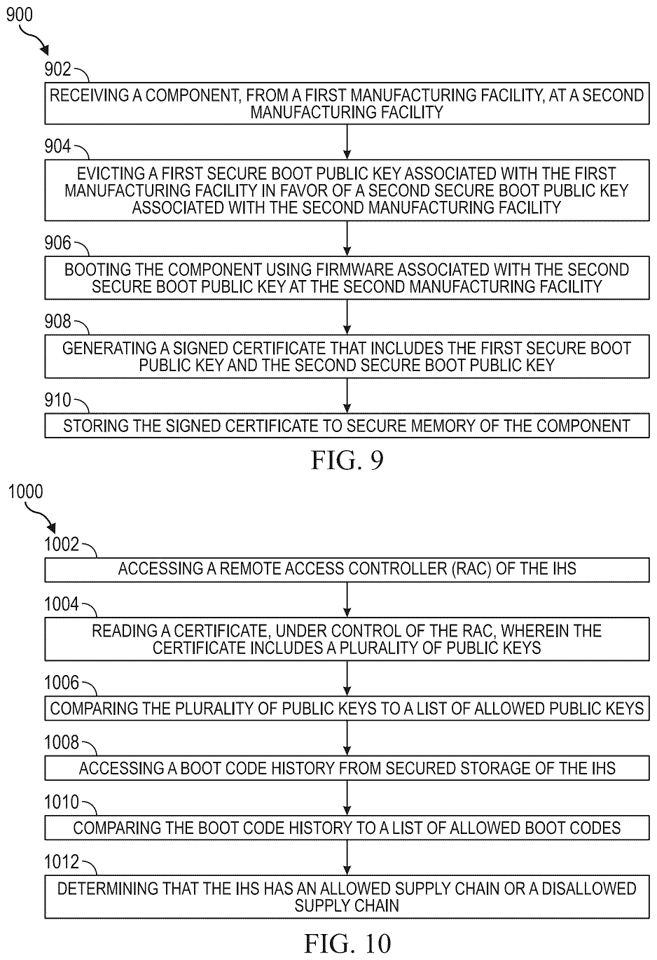

FIG. 9 is an illustration of an example method 900, according to some embodiments. The actions of FIG. 9 may be performed by one or more tools in an assembly facility, such as the L10 facility in the examples above. The one or more tools may be implemented by one or more IHSs, which include execute computer-readable code to provide the functionality of the one or more tools.

Action 902 includes receiving a component, from a first manufacturing facility, at a second manufacturing facility. For instance, the L10 facility may receive a component, such as motherboard 310, from the L5 facility.

Action 904 includes evicting a first secure boot public key that is associated with the first manufacturing facility. The evicting of action 904 may include evicting the first secure boot public key in favor of a second secure boot public key that is associated with the second manufacturing facility. For instance, action 904 may be similar to action 810 of FIG. 8. The evicting of action 904 includes removing the ability of the first secure boot public key to be used for booting and instead granting the ability to be used for booting to the second secure boot public key. The evicting may be performed in any appropriate manner.

Action 906 includes booting the component using firmware associated with the second secure boot public key at the second manufacturing facility. For instance, the second manufacturing facility may boot the SoC on the motherboard using firmware that is associated with the second secure boot public key. In the example of FIG. 8, the L10 manufacturing facility may boot the SoC using the L10 product key, as in action 814.

Although not specifically shown in method 900, further actions may include assembling an IHS using the component (e.g., motherboard) and other components.

Action 908 includes generating a signed certificate that includes the first secure boot public key and the second secure boot public key. This may be the same as or similar to the actions 820-822 of FIG. 8. For instance, the certificate may be using a private key of the second facility (e.g., an HSM). The certificate may conform to any appropriate format, such as an SCV certificate or other format. In this example, the certificate may also include identities of various hardware components of the IHS to which the component is to be installed.

Action 910 includes storing the signed certificate to secure storage of the component. For instance, the certificate may be stored to secure storage 258, which may be accessed by an RAC, such as RAC 255. In some examples, the secure storage, the SoC, and the RAC may be disposed on the same motherboard, which is received from facility L5. However, the scope of implementations may include any secure storage of the IHS, such as may be accessed by an RAC, the SoC, another processor, and/or the like.

Action 910 may include securely storing the signed certificate to either the second manufacturing facility or another facility, thereby allowing for auditing by a manufacturer of the IHS.

FIG. 10 is an illustration of an example method 1000, according to some embodiments. The actions of method 1000 may be performed by one or more tools in an assembly facility, such as the L10 facility in the examples above. The actions of method 1000 may also be performed by one or more tools under control of an end-user, such as an end-user to whom the assembled IHS is shipped. The one or more tools may be implemented by one or more IHSs, which include execute computer-readable code to provide the functionality of the one or more tools.

Method 1000 assumes that the end-user has received an IHS and that the IHS stores a first hardware certificate (e.g., the certificate from action 822 of FIG. 8) and a second software certificate (e.g., the certificate from action 830 of FIG. 8). Furthermore, the IHS may store the certificates in one or more secured memories.

Action 1002 includes accessing an RAC of the IHS. Action 1004 includes reading a certificate, under control of the RAC, wherein the certificate includes a plurality of public keys. Reading a certificate may include parsing the content of the certificate. In one example, the RAC may have access to secure storage, and that secure storage may store the certificate. Reading the certificate may also include verifying authenticity of the certificate, such as verifying that the certificate was signed using a private key of a certificate authority. The RAC may access the certificate and allow an administrator to view some or all of the information in the certificate.

Action 1006 includes comparing the plurality of public keys to a list of allowed public keys. For instance, in action 1006, the public keys may include secure boot public keys associated with one or more facilities in the supply chain of the IHS. Example secure boot public keys may include the L0 secure boot public key, the L5 secure boot public key, and the L10 product key.

The comparing at action 1006 may include accessing the list of allowed public keys, where the list may be under control of the end-user, the manufacturer of the IHS, or an approved third-party. In some examples, the list of allowed public keys may be set by the end-user to comply with internal or external policies. For instance, some regulations may include requirements to use components originating from some jurisdictions or may include requirements not to use components from some jurisdictions. Additionally or alternatively, some end-users may have company-based policies to either use or not to use components originating from some jurisdictions. As noted above, the public keys may be associated with respective facilities, and those facilities may be known to be located in certain jurisdictions. Thus, the list of public keys may be indicative of jurisdictions within the supply chain of the IHS.

While action 1006 refers to a list of allowed public keys, additionally or alternatively, action 1006 may include comparing the plurality of public keys to a list of disallowed public keys. The list of disallowed public keys may be based on policies and regulations, such as those discussed above. In any event, the comparing at action 906 may indicate whether one or more components of the IHS comply with supply chain jurisdiction regulations.

Action 1008 includes accessing a boot code history from secured storage of the IHS. For instance, the boot code history may be read by parsing the content of a second certificate, such as a software certificate. Action 1008 may also include verifying authenticity of the software certificate, such as verifying that the software certificate was signed using a private key of a certificate authority. Action 1010 may include comparing the boot code history to a list of allowed (or disallowed) boot codes. As noted above, boot codes may be associated with respective facilities, and those facilities may be known to be located in certain jurisdictions. Thus, the boot codes may be indicative of jurisdictions within the supply chain of the IHS. The comparing of action 1010 may indicate whether one or more components of the IHS comply with supply chain jurisdiction regulations.

Action 1012 includes determining of the IHS has an allowed supply chain or a disallowed supply chain. Action 1012 may be based upon the comparing actions 1006 and 1010. If it is determined that the IHS has a disallowed supply chain, the assembly facility may reject the IHS or find another buyer for the IHS. Similarly, if the end-user determines that the IHS has a disallowed supply chain, the end-user may reject the IHS and request a different IHS in compliance with its policies or regulations. On the other hand, if it is determined that the IHS has an allowed supply chain, then both the assembly facility and the end-user may accept the IHS.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
receiving a component, from a first manufacturing facility, at a second manufacturing facility;
evicting a first secure boot public key associated with the first manufacturing facility in favor of a second secure boot public key associated with the second manufacturing facility;
booting the component using firmware associated with the second secure boot public key at the second manufacturing facility;
generating a signed certificate that includes the first secure boot public key and the second secure boot public key; and
storing the signed certificate to secure storage of the component.

2. The method of claim 1, wherein generating the signed certificate comprises:
generating a hardware inventory of the component; and
including the hardware inventory in the signed certificate.

3. The method of claim 2, wherein generating the signed certificate comprises:
signing the certificate with a private key associated with the second manufacturing facility.

4. The method of claim 1, further comprising:
generating a hash of boot code associated with the second secure boot public key;
storing the hash in memory of the component, wherein the memory of the component further stores an additional hash associated with the first secure boot public key;
generating a data structure that includes the hash and the additional hash from the memory of the component;
signing the data structure to generate an additional signed certificate; and
storing the additional signed certificate to the secure storage of the component.

5. The method of claim 4, wherein signing the data structure comprises:
signing the data structure with a private key associated with the second manufacturing facility.

6. The method of claim 4, wherein generating the data structure comprises:
generating a code inventory of the component; and
including the code inventory in the data structure prior to signing.

7. The method of claim 1, wherein the first manufacturing facility and the second manufacturing facility are located in different countries, and wherein the signed certificate indicates a supply chain including the different countries.

8. The method of claim 1, further comprising:
installing the component in an information handling system (IHS) having a plurality of additional components, wherein generating the signed certificate comprises:
generating a hardware inventory of the IHS; and
including the hardware inventory in the signed certificate.

9. The method of claim 8, further comprising: installing a firmware image, that includes the firmware, to the IHS, wherein the firmware image is used across a plurality of IHS types.

10. An IHS (Information Handling System) comprising:
one or more processors;
one or more memory devices coupled to the processors, the memory devices storing computer-readable instructions that, upon execution by the processors, cause the IHS to:
access a remote access controller (RAC) of the IHS;
read a certificate, under control of the RAC, wherein the certificate includes a plurality of public keys;
compare the plurality of public keys to a list of allowed public keys; and
determine that the IHS has an allowed supply chain or a disallowed supply chain based on comparing the plurality of public keys to the list of allowed public keys.

11. The IHS of claim 10, wherein the IHS is configured to:
read a signed data structure of the IHS, wherein the signed data structure includes a code inventory of the IHS;
compare at least a portion of the signed data structure to a list of allowed code; and
determine that the IHS has an allowed supply chain or a disallowed supply chain based on comparing the at least a portion of the signed data structure to the list of allowed code.

12. The IHS of claim 11, wherein the computer-readable instructions to cause the IHS to read the signed data structure includes computer-readable instructions to cause the IHS to:
read the at least a portion of the signed data structure, which includes a first hash indicative of a first secure boot code and a second hash indicative of a second secure boot code.

13. The IHS of claim 10, wherein the computer-readable instructions to cause the IHS to read the certificate includes computer-readable instructions to cause the IHS to:
determine that the certificate is signed by a certificate authority.

14. The IHS of claim 10, wherein the computer-readable instructions to cause the IHS to read the certificate includes computer-readable instructions to cause the IHS to:
parse content of the certificate, including a hardware inventory of the IHS.

15. A computer-readable storage device having instructions stored thereon, wherein execution of the instructions by one or more processors of the an information handling system (IHS) causes the one or more processors to:
boot a processor of a baseboard that has been received from a first manufacturing facility at a second manufacturing facility;
evict a first secure boot public key, associated with the first manufacturing facility, in favor of a second secure boot public key, associated with the second manufacturing facility, from the processor;
boot the processor using firmware associated with the second secure boot public key at the second manufacturing facility;
generate a signed certificate that includes the first secure boot public key and the second secure boot public key; and
store the signed certificate to secure storage of the motherboard.

16. The computer-readable storage device of claim 15, further comprising instructions to cause the one or more processors to:
access contents of the signed certificate;
compare the contents of the signed certificate to a list of or disallowed allowed public keys; and
determine whether the IHS has an allowed supply chain or a disallowed supply chain based on comparing the contents of the signed certificate.

17. The computer-readable storage device of claim 15, wherein the instructions to cause the one or more processors to evict the first secure boot public key includes instructions to cause the one or more processors to:
cause the first secure boot public key to be unavailable for booting the processor.

18. The computer-readable storage device of claim 17, wherein the instructions to cause the one or more processors to evict the first secure boot public key includes instructions to cause the one or more processors to:
write the second secure boot public key to one-time programmable (OTP) memory of the IHS.

19. The computer-readable storage device of claim 15, wherein the IHS conforms to a device type, and wherein the second secure boot public key is associated with the device type.

20. The computer-readable storage device of claim 15, wherein the instructions to cause the one or more processors to generate the signed certificate comprises instructions to cause the one or more processors to:
cause a data structure, including the first secure boot public key and the second secure boot public key, to be signed by a private key of a certificate authority.
